(19) United States
(12) Patent Application Publication
(10) Pub. No.: US 2025/0369126 A1
(43) Pub. Date: Dec. 4, 2025

(54) LOW TEMPERATURE PRODUCTION OF HYDROGEN PEROXIDE

(71) Applicant: HPNow ApS, Søborg (DK)

(72) Inventors: Rasmus Frydendal, Brønshøj (DK); Arnau Verdaguer Casadevall, København NV (DK); Ziv Gottesfeld, Tel Aviv (IL); Rajath Sathyadev Rajmohan, Rødovre (DK)

(21) Appl. No.: 18/680,833

(22) Filed: May 31, 2024

(51) Int. Cl. C25B 1/30; C25B 9/23; C25B 9/67; C25B 15/021; C25B 15/027; C25B 15/08

(52) U.S. Cl. CPC C25B 1/30; C25B 9/23; C25B 9/67; C25B 15/021; C25B 15/027; C25B 15/085; C25B 15/087

(57) ABSTRACT

Embodiments for an apparatus for producing hydrogen peroxide are provided. The apparatus includes a heat exchanger configured to remove heat from deionized water prior to passing the deionized water through the anode passage of one or more cells. The apparatus is also configured to oxidize the deionized water in the anode passage of the one or more cells. The apparatus also includes a controller configured to control the heat exchanger and a first one or more temperature sensors electrically coupled to the controller. The first one or more temperature sensors are configured to provide a first temperature reading based on a temperature of the one or more cells, wherein the controller is configured to control the heat exchanger to maintain the first temperature reading at or below a first temperature threshold.

### BACKGROUND

An electrolytic cell that generates hydrogen peroxide from oxygen and water is generally useful for on-site creation of hydrogen peroxide for applications such as disinfection and water treatment. These cells are designed to meet the simultaneous requirements to deliver oxygen, electrons, and protons to a high surface electrode to affect the two-electron reduction of oxygen to hydrogen peroxide. These cells use a proton exchange membrane (PEM) such as Nafion™ (produced by The Chemours Company) or another proton or anion-conducting electrolyte (e.g., Fumasep® produced by FUMATECH BWT GmbH) to provide a local ion source for the reduction reaction.

For cells such as these, heat generated by the cells has been considered a positive feature, because the ionic conductivity of the PEM increases for temperatures above room temperature. This increases the electrical efficiency of the cell. For hydrogen electrolyzers and fuel cells based on Nafion™ or other PEMs, optimum performance is typically reported at 60 to 80 degrees Celsius.

The traditional approach in the PEM electrolyzer field has been to focus primarily on electrical efficiency, especially for larger scale generation at high current densities where resistance losses are a primary consideration. Thus, much of the literature on hydrogen peroxide generation in membrane electrochemical assemblies operates at room temperature and accepts the elevated temperatures that naturally occur during operation.

### BRIEF DESCRIPTION

Embodiments for an apparatus for producing hydrogen peroxide are provided. The apparatus includes one or more electrolytic cells. Each cell has an anode, a cathode, an anode passage for passing fluid proximate the anode, and a cathode passage for capturing hydrogen peroxide produced at the cathode. The apparatus also includes a heat exchanger configured to remove heat from deionized water. The apparatus also includes one or more conduits fluidly coupling the deionized water downstream of the heat exchanger to the anode passage of the one or more electrolytic cells. The apparatus is configured to remove heat from deionized water with the heat exchanger and pass the deionized water through the anode passage of the one or more cells after removing heat from the deionized water. The apparatus is also configured to oxidize the deionized water in the anode passage of the one or more cells. The apparatus also includes a controller configured to control the heat exchanger and a first one or more temperature sensors electrically coupled to the controller. The first one or more temperature sensors are configured to provide a first temperature reading based on a temperature of the one or more cells, wherein the controller is configured to control the heat exchanger to maintain the first temperature reading at or below a first temperature threshold.

Embodiments also include a method of producing hydrogen peroxide. The method includes removing heat from deionized water with a heat exchanger. After removing heat from the deionized water, the deionized water is passed through an anode passage of the one or more electrolytic cells. Each cell has an anode, a cathode, the anode passage for passing fluid proximate the anode, and a cathode passage for capturing hydrogen peroxide produced at the cathode. The method also includes oxidizing the deionized water in the anode passage of the one or more cells. The method also includes sensing a first temperature indicative of the temperature of the one or more cells to obtain a first temperature reading; The method also includes controlling one or more of the heat exchanger and a flow rate of water through the anode passage of the one or more cells to maintain the first temperature reading at or below a first temperature threshold.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a cross-sectional representation of an example electrolytic cell for the production of hydrogen peroxide;

FIG. 2 is a block diagram of an example system for the production of hydrogen peroxide that includes one or more cells of FIG. 1;

FIG. 3 is a flow-diagram of an example method of controlling a temperature of the cells in the system of FIG. 2; and

FIG. 4 is a chart showing the Faradaic efficiency of an electrolytic cell with and without controlling the temperature of the cell.

### DETAILED DESCRIPTION

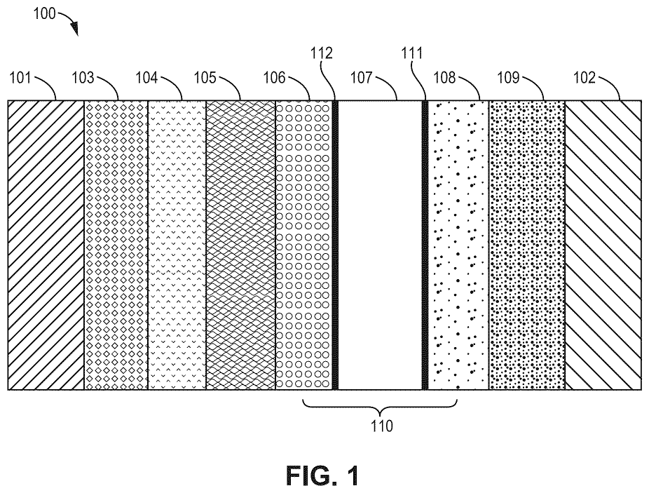

FIG. 1 is a cross-sectional representation of an example electrolytic cell 100 for production of hydrogen peroxide. The cell 100 includes a membrane electrode assembly (MEA) 110 at which the electrochemical reaction to produce hydrogen peroxide takes place. The MEA 110 includes a cathode 106, an anode 108, with a membrane 107 therebetween, with the cathode 106 and anode 108 in contact with the membrane 107. In an example, the MEA 110 is less than 1 millimeter thick from the cathode 106 to the anode 108. The membrane 107 separates and electrically isolates the cathode 106 from an anode 108 while allowing ions to transfer therethrough and facilitate the electrochemical reaction. As such, the membrane 107 is an ionically conductive membrane, such as a proton exchange membrane (PEM), but other types of membranes can also be used, including an alkaline exchange membrane, functionalized ion exchange resin, or functionalized conducting polymer.

The anode 108 of the MEA 110 can be composed of an electrically conductive material, such as metal, and is configured for an oxidation reaction generating protons via, for example, oxidation of water. The anode 108 can include a catalyst layer 111 disposed on a side of the anode 108 adjacent to the membrane 107, such that a first side of the membrane 107 contacts the catalyst layer 111. The catalyst layer 111 is composed of a different material than the main body of the anode 108, wherein the material is selected to help facilitate the reaction. For an acidic membrane 107, example materials for catalyst layer 111 of the anode 108 include platinum, ruthenium oxide, or iridium oxide. For an alkaline membrane 108, example catalyst materials for the catalyst layer 111 of the anode 108 include nickel and nickel-iron.

The cathode 106 is a gas diffusion cathode and can be composed of carbon materials with or without coating for modifications of hydrophobicity. The cathode 106 can also have a catalyst layer 112 similarly disposed on a side thereof, adjacent to the membrane 107, such that a side of the membrane 107 that is reverse of the anode 108 contacts the catalyst layer 112. The catalyst layer 112 is composed of a different material than the main body of the cathode 106, wherein the material is selected to help facilitate the reaction. Example materials for catalyst layer 112 include a high surface area carbon and Co-porphyrin.

A cathode current collector 101 and an anode current collector 102 are disposed outward of the cathode passage 105 and the anode passage 109 and can be composed of metal. Immediately adjacent to the cathode current collector 101 is a conductive gas distribution layer 103, which can be composed of titanium mesh and receives oxygen-containing gas on one end and distributes the gas through the mesh. Adjacent to the gas distribution layer 103 is a porous sinter plate 104, which separates the gas distribution layer 103 from a cathode reaction passage 105. The porous sinter plate 104 can be composed of titanium and allows the oxygen-containing gas to diffuse from the gas distribution layer 103 into the cathode reaction passage 105. The cathode reaction passage 105 can be composed of porous gas diffusion layers that allow the oxygen-contain gas to disperse throughout and come into contact with water. The water can enter the cathode reaction passage 105 at a first end.

The anode 108 oxidizes water in an anode reaction passage 109 to create O₂ and H⁺. The water that is oxidized enters the anode reaction passage 109 at one end and exits the opposite end along with the O₂ formed during oxidation. The anode passage 109 can be composed of a conductive (e.g., titanium) felt and/or mesh through the conductive felt and/or mesh diffuses to approach the anode 108. The conductive felt and/or mesh 109 is in contact with the anode current collector 102 to complete the cell 100.

It should be understood that FIG. 1 is merely an example cell structure and is not to scale. Other cell structures can be used. In particular, the specific configuration of the anode, anode passage, and anode current collector can vary while still providing electrical coupling between the anode current collector 102 and the anode 108, allowing water to flow through the anode passage 109 and providing physical stability of the cell 100. More detail on example electrolytic cells for hydrogen peroxide production is provided in U.S. Patent Publication No. 2024/0060195, which is hereby incorporated herein by reference.

In operation, electrochemical reduction of oxygen to peroxide and oxidation of water to oxygen occurs in the MEA 110. Electrical power is coupled to the cathode current collector 101 and the anode current collector 102. Deionized water (H₂O) is flowed through the anode passage 109 and the cathode passage 105, oxygen-containing gas is provided to the oxygen-diffusion layer 103. In an example, the oxygen-containing gas is pure oxygen or air. The deionized water in the anode passage 109 is oxidized to produce protons and electrons according to the equation: H₂O→½O₂+2e⁻+2H⁺. The O₂ produced leaves the anode passage 109 along with excess water. In an example, the membrane 107 can be acid in nature, such that the H⁺ produced diffuses through the anode 108 and the membrane 107 to reach the cathode 106. In other examples, the membrane 107 can be alkaline in nature. In acid, the oxygen reduction reaction at the cathode 106 proceeds according to the equation: O₂+2e⁻+2H⁺→HOOH. This reaction consumes protons and electrons. The catalysts 111, 112 and the anode 108 and cathode 106 facilitate the respective reactions. In an alternative example, hydrogen deionized water is not flowed through the anode passage 109. Instead, hydrogen is injected into the anode passage 109 to diffuse through the membrane 107 to the cathode 105.

Deionized water can optionally be provided to the cathode passage 105. This water mixes with hydrogen peroxide that is produced and dilutes it. Additionally, about three water molecules pass through the membrane 107 for every proton that passes through so there is an additional slow flux of water from the anode passage 109 to the cathode passage 105 alongside the protons. The water and hydrogen peroxide solution generated in the cathode passage 105 is output from the cathode passage 105.

Multiple cells 100 can be fluidically arranged in parallel fed by a common supply of oxygen-containing gas and deionized water. The water and hydrogen peroxide solution from the multiple cells 100 can be combined to form a composite solution that can then be stored or flowed to the desired location.

The Faradaic efficiency of peroxide production refers to the percentage of electrons that are productively converted into hydrogen peroxide that is extracted from the electrolytic cell. Losses in efficiency can occur if the peroxide molecules remain at the catalyst surface and undergo a further two-electron reduction to convert them to water, or if oxygen reacts to form water via the 4-electron pathway. Losses can also occur if the peroxide reacts with the catalyst surface to irreversibly oxidize it. The oxidation reaction is particularly pernicious because it undermines the effectiveness of the catalyst.

The electrical efficiency of the cell 100 is reduced by the voltage overpotential at the electrodes, and the ionic resistance of the electrolyte. These resistive losses are converted to heat in the electrode stack, which raises the local temperature of the catalyst layers 111, 112.

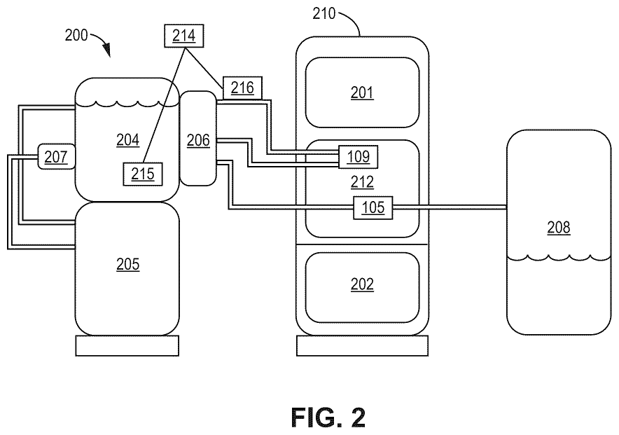

FIG. 2 is a block diagram of an example system 200 for producing hydrogen peroxide including one or more cells 100. The system 200 can include a cabinet 210, which physical houses an electrolytic cell stack 212, a power source 201, and a gas source 202. The electrolytic stack 212 can include one or electrolytic cells 100 fluidically arranged in parallel. The power source 201 can be anything capable of supplying the necessary power to the cells 100, such as a converter that converts line power, a battery-based supply, or a generator. The gas source 202 can be any suitable source of oxygen-containing gas such as a tank of pressurized oxygen gas, compressed air, or an oxygen enrichment system. The gas source 202 is fluidly coupled to the oxygen-gas distribution layer 103 of each cell 100 in the stack 212. Although a particular physical layout is depicted and described with respect to FIG. 2, it should be understood that the subject matter herein is not limited to that particular physical layout.

The system 200 can also include a reservoir 204 for holding deionized water. The deionized water can be supplied to the reservoir 204 from a water deionization system, which may be present along with the system 200. Deionized water is preferred for use in the cells 100 as any ions in the water may react with the membrane 107 or with the catalyst layers 111, 112 and degrade performance. In an example, the conductivity of water is <1 μS/cm. The system 200 can also include one or more pumps 206, configured to pump water from the reservoir 204 to the stack 212 for flowing through the anode passage 109 and cathode passage 105 of each cell 100. To provide separate flow rates for water through the anode passage 109 and the cathode passage 105 of each cell, a first one or more conduits can fluidly couple water from the reservoir 204 to the anode passage 109 of each cell 100 and distinct second one or more conduits can fluidly couple water from the reservoir 204 to the cathode passage 105 of each cell 100.

In an alternative example, deionized water can be received by the system 200 from a pressurized source (e.g., a tap). In some examples, a portion of the water output from the anode passage 109 can be directed to the cathode passage 105 for use as the input water for the cathode passage 105 instead of using water from the reservoir 204 or pressurized source. Hydrogen peroxide solution output from the cathode passage 105 of each cell 100 can be collected in a collection reservoir 208. All or a portion of the water output from the anode passage 109 of each cell 100 can be recirculated back to the reservoir 204, discarded, or directed to the cathode passage 105 as discussed above.

The system 200 also includes a heat exchanger 205 that is configured to remove heat from the water prior to the water flowing through the anode passage 109 of each cell 100. In this example, the system 200 includes a pump 207 to circulate water from the reservoir 204 through the heat exchanger 205 to reduce and maintain the temperature of the water in the reservoir 204 at or below a desired temperature. In an example, the heat exchanger 205 can include a coil immersed in the deionized water reservoir, such that the water in the reservoir 204 is cooled directly without having to pump the water through the heat exchanger 205. The water from the reservoir 204, which has been cooled to a desired temperature, is then pumped through the anode passage 109 of each of the cells 100. In other examples, the heat exchanger 205 can be disposed inline between the reservoir 204 and the electrolytic stack 212 to remove heat from the water as it flows from the reservoir 204 to the stack 212. In yet other examples, the water can be received by the system 200 as a flowing source and the heat exchanger 205 can remove heat from the water as it is received by the system 200. In still other examples, the heat exchanger 205 includes multiple modules, each of which remove heat from the water at different locations. For example, an inline heat exchanger between the reservoir 204 and the stack 212 can be used in addition to a heat exchanger the reduces the temperature of the water in the reservoir 204. Any suitable configuration of the heat exchanger 205 can be used to cool the water that is flowed into the cells 100.

The system 200 can also include one or more controllers 214 coupled to the heat exchanger 205, circulation pump 207, and/or flow rate pumps 206 (or valves) to control operation of the system 200 to maintain the temperature of the cells 100 at a lower value than would be achieved with uncontrolled operation. The controller(s) 214 can control the heat exchanger 205, circulation pump 207, and/or flow rate pumps 206 (or valves) to control the temperature and/or flow rate of the water input into the anode passage 109 and/or cathode passage 105. The controller(s) 214 can be electrically coupled to one or more sensors 215, 216 that are configured to sense temperature at various locations with the system 200 and provide temperature readings to the controller(s) 214. The controller(s) 214 can adjust operation of the heat exchanger 205, circulation pump 207, and/or flow rate pumps 206 (or valves) to maintain the temperature readings from the sensor(s) 215, 216 at or below respective threshold temperatures to maintain the overall temperature of the system 200.

The controller 214 can include one or more processing devices, such as a microprocessor, for executing computer readable instructions. The instructions, when executed by the one or more processing devices, cause the one or more processing device to control the temperature(s) as described herein. The instructions can be stored (or otherwise embodied) on or in an appropriate storage medium or media (such as a hard drive or other non-volatile storage) of the controller 214 from which the instructions are readable by the processing device(s) for execution thereby. The one or more processing devices can be coupled to the storage medium or media to access the instructions therefrom. The controller 214 can include memory coupled to the processing device(s) for storing instructions (and related data) during execution by the processing device(s). Memory can comprise any suitable form of random-access memory (RAM) now known or later developed, such as dynamic random-access memory (DRAM), and may comprise other types of suitable memory. The controller 214 also includes at least one communication interface (e.g., an ethernet port, a wi-fi transceiver, or a Bluetooth transceiver) for communicatively coupling to external device(s).

By way of the communication interface, the controller 214 can communicate with an external device such as a smart phone or personal computer. A user on an external device can remotely control or otherwise command the controller, for example, to monitor or adjust operation of the system 200. In an example, the system 200 can include a human machine interface (e.g., a touchscreen, one or more switches, and/or knobs) that are electrically coupled to the controller 214 from which a user can provide input for the controller 214.

It has been discovered that, counter to traditional approaches, it is beneficial to reduce the temperature of the cell(s) 100 in the system 200 from their normal operating temperature. In an example, a cell temperature in the range of 10-30 degrees Celsius is desired to maximize the long term Faradaic efficiency of the cell(s) 100 and lower system operating costs. This determination is inclusive of costs and parasitic losses involved in powering the cooling. Moreover, the subject matter herein provides for an efficient means of cooling the cell(s) 100, by cooling the deionized water that is flowed through the cell(s) 100 for their reactions. The cooled water flowing through the cell(s) 100 removes heat from the cell(s) 100. This allows the deionized water to be used as a cooling liquid as well as a water source to facilitate electrochemistry. This dual role for the deionized water allows for control of the temperature inside the stack 212, independent of size of the cells 100 or resistive heat losses in the cells 100. The controller 214 can control temperature and/or flow rate of the water input into the anode passage 109 and/or cathode passage 105 of the cell(s) 100 to maintain the temperature of the cells 100 at a low value, thereby increasing the Faradaic efficiency of operation of the cell(s) 100.

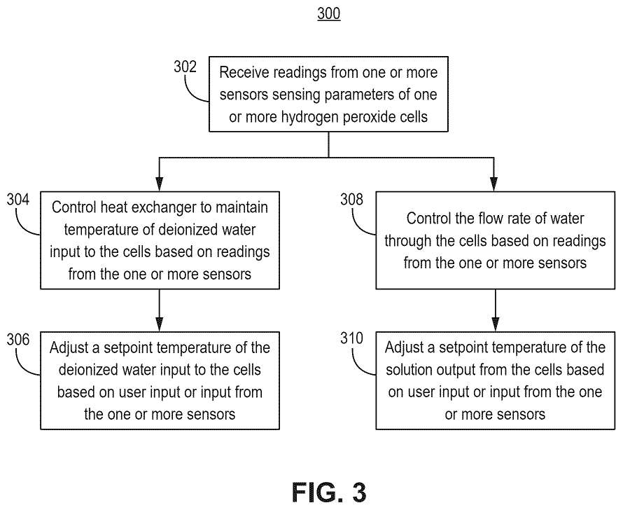

FIG. 3 is a flow-diagram of an example method 300 of controlling the temperature of the cell(s) 100 in system 200. Method 300 is an example control loop showing example steps that can be used to control the temperature of the cell(s) in system 100. It should be understood that particular steps shown in FIG. 3 can be excluded and additional steps can be added.

At block 302, the controller(s) 214 receives temperature readings from one or more sensors 215, 216 configured to sense a parameter of the system 200. The one or more sensors 215, 216 can include one or more temperature sensors configured to sense a temperature at respective locations of the system 200.

At block 304, the controller(s) 214 controls the heat exchanger 205 and pump 207 (if present) to maintain the temperature of the deionized water at a desired low value. To do so, a first one or more temperature sensors 216 can be disposed to sense a temperature of the deionized water prior to the water flowing through the anode passage 109 of each cell 100. In an example, the one or more first temperature sensors 216 are configured to sense a temperature of the water in the reservoir 204 and/or in the flow path of the water upstream and/or downstream of the heat exchanger 205. The controller(s) 214 can control the heat exchanger 205 and pump 207 to maintain the temperature readings from the first one or more temperature sensors 215 to at or below a first threshold temperature. The controller 214 can control the pump 207 to control the flow rate of water through the heat exchanger 205 and/or can control the heat exchanger 205 to control the rate of heat removal from the water. The controller 214 can adjust operation of the heat exchanger 205 and pump 207 maintain the temperature of the water at or below the threshold temperature.

At block 306, the controller(s) 214 can adjust the first threshold temperature (first setpoint) based on input from a user or based on readings from the one or more sensors 215, 216. In an example, the controller(s) 214 can receive input from a user via a human machine interface or from an external device (e.g., mobile phone) corresponding to a manual change of the first threshold temperature. In another example, the controller(s) 214 can automatically adjust the first threshold temperature based on temperature readings from a second one or more temperature sensors 216. The second one or more temperature sensors 216 can be configured to sense a temperature that is indicative of the temperature of the cell(s) 100. Any appropriate temperature that is indicative of the temperature of the cell(s) 100 can be tested, including a temperature that is not the actual temperature of the cell. For example, the second one or more sensors 216 can be disposed to sense a temperature of the water/solution output from either or both of the anode passage 109 or the cathode passage 105 of each cell 100. This output water/solution may not be the same as the actual temperature of a cell 100, but the output water/solution typically varies casually with the temperature of the cell 100. That is, as the temperature of the cell 100 increases, the temperature of the output water/solution increases and vice versa. Thus, the output water/liquid can be used as an indicator of the overall temperature of the cell 100. In another example, the second one or more sensors 216 are configured to measure a temperature of the cathode 106 or the anode 108.

The controller(s) 214 can be configured to maintain the temperature of the cell(s) 100 at a desired temperature by controlling the first threshold temperature. In particular, the controller(s) 214 can be configured to reduce the first threshold temperature to reduce the temperature readings from the second one or more temperature sensors 216 and to raise the first threshold temperature to increase the temperature readings from the second one or more temperature sensors 216. The controller(s) 214 can control the first threshold temperature in order to maintain the temperature readings from the second one or more temperature sensors 216 at or below a second threshold temperature. In this way, the temperature of the input water to the cells(s) 100 can be controlled based on the temperature of the cell(s) 100.

In an alternative example, instead of controlling the heat exchanger 205 (and optionally the pump 207) to maintain the water at or below a first threshold temperature, the controller(s) 214 can control the operation of the heat exchanger 205 (and optionally the pump 207) without regards to a first threshold temperature for the water input to the cell(s) 100. That is, the controller(s) 214 can be configured to increase the heat removed from the water by the heat exchanger to reduce the temperature readings from the second one or more temperature sensors 216 and to reduce the heat removed from the water by the heat exchanger to increase the temperature readings from the second one or more temperature sensors 216. This control can be done regardless of the current temperature of the water input to the cell(s) 100, notwithstanding that there may be certain limits to operation, such as a lower and upper limit on temperature of the water input to the cell(s) 100.

At block 308, the controller(s) 214 can, in addition to or instead of controlling the heat exchanger 205 and pump 207, control the flow rate of water through the anode passage 109 and/or cathode passage 105 of each cell 100. The controller 214 can be electrically coupled to the one or more pumps 206 to control the flow rate of water through the anode passage 109 and/or cathode passage 105 of each cell 100. In examples where the water is received as a flowing source, the controller 214 can control the flow rate by controlling one or more valves that restrict the flow of water through respective conduits to the anode passage 109 and/or cathode passage 105 of each cell 100.

The controller(s) 214 can control the flow rate of water through the anode passage 109 and/or cathode passage 105 of each cell 100 based on readings from the one or more sensors 215, 216. In particular, the controller(s) 214 can control the flow rate based on readings from the second one or more sensors 216, which are configured to sense a temperature of the cell(s) 100. The controller(s) 214 can be configured to increase the flow rate to reduce the temperature readings from the second one or more temperature sensors 216 and to decrease the flow rate to increase the temperature readings from the second one or more temperature sensors 216. Thus, the controller(s) 214 can be configured to control the flow rate to maintain the temperature readings from the second one or more sensors 216 at or below the second threshold temperature. In an example, the controller(s) 214 can be configured to simultaneously control the heat exchanger 205, pump 207, and pump(s) 206 (or valves) to maintain the temperature readings from the second one or more sensors 216 at or below the second threshold temperature.

At block 310, the controller(s) 214 can adjust the second threshold temperature (second setpoint). In an example, the second threshold temperature can be adjusted based on input from a user. In an example, the controller(s) 214 can receive input from a user via a human machine interface or from an external device (e.g., mobile phone) corresponding to a manual change of the second threshold temperature.

In another example, the controller(s) 214 can receive readings from one or more power sensors that provide readings of the power drawn by the cell(s) 100 of the system 100. The controller(s) 214 can control the heat exchanger 205, pump 207, and pump(s) 206 (or valves) based on these power readings with or without receiving readings from the first and/or second one or more temperature sensors 215, 216. Because the system 200 generally operates more efficiently at lower temperatures, the controller(s) 214 can be configured to take actions to adjust the temperature of the system (e.g., adjust the first and/or second threshold temperature) to maintain the power readings at or below a desired power threshold. This can include controlling the heat exchanger 205, pump 207, and pump(s) 206 (or valves) directly, without regards to either or both the first or second threshold temperatures, based on the power readings.

In examples where a stack 212 includes multiple cells 100 fluidically coupled in parallel, the controller(s) 214 can control the temperature and/or flow rate of a single common flow of water input to all of the multiple cells 100 or can independently control one or more distinct flows of water input to respective sets of one or more of the cells 100.

In an alternative example, the stack 212 is cooled in other manners in addition to, or instead of, cooling the water input to the anode passage 109. For example, an external cooling mechanism could be used to remove heat from the one or more cells 100 based on the second one or more temperature sensors 216 sensing a temperature of the solution output from the cathode passage 105 and/or the water output from the anode passage 109. Any suitable external cooling mechanism could be used, such as a liquid-based or air-based cooling system. An alternative example in which the stack 212 is cooled externally based on the temperature of the solution output from the cathode passage 105 is particularly useful for examples in which hydrogen is injected into the anode passage 109 instead of deionized water.

Large scale peroxide electrolytic cells generate a considerable amount of heat during use, thanks to the interfacial resistances at the electrodes and the bulk resistance of the solid electrolyte. The Faradaic efficiency of peroxide electrolytic cells can fall substantially as the cells better retain their heat. This is especially seen in larger cells, which exchange less of their generated heat with the surrounding environment.

For example, the temperature of a peroxide electrolytic cell that generates 5 L/hr of 1% peroxide can rise to 38° C. or greater during constant use. At this temperature there can be a destructive reaction of peroxide with the gas diffusion cathode that lowers Faradaic efficiency and cell performance. Without being limited by theory, it is believed that at elevated temperatures the ionic conductivity of the solid electrolyte increases, which improves electrical efficiency; at the same time, the rate of reduction of the peroxide to water also increases, which reduces electrical efficiency. In experiments, a significant reduction of efficiency is seen at elevated temperature relative to room temperature or below. Thus, cooling the assembly can usefully improve overall efficiency, in contrast with what would be expected from common practice.

The output water from the anode passage 109 may accumulate corrosion products or impurities from the anodes, so that the water cannot be directly returned to the system (deionized water reservoir or cathode passage 105) for fear of contaminating the cell(s) 100. In one embodiment, the water reused from the anode passage 109 is flowed through a particle filter, carbon filter, and/or deionizing resin filter to regenerate pure water. The deionizing resin may be the existing system deionizing resin, such that the output water re-enters the deionized water holding tank, and the drain is wholly or partially eliminated. This configuration saves cost as long as the output water is of higher purity than water output from reverse osmosis, as would be used in a convention RODI (reverse osmosis deionized water) water treatment system.

Alternatively, the water output from the anode passage 109 may be maintained as an independent loop from water input to the cathode passage 105, with its own independent water filter and/or deionization resin filter. In such as independent loop, water is slowly consumed, turning to oxygen over time. The volume of this anode water loop is measured by a simple sensor such as a fill sensor, to ensure sufficient water is available to fill the anode loop at all times.

In an example, the materials used in cell(s) 100 and the flow of the water through the cell(s) can be selected to reduce contamination, such that the output water from the anode passage 109 can be recirculated into the deionized water holding tank, or directly into the cathode, with minimal or no further treatment. In an example, the holding tank and piping are composed of non-metallic material, ideally a type of plastic such as polypropylene or polyethylene, the heat exchanging components are made of titanium or stainless steel, and the recirculation pump 207 and/or pumps 206 have no metal components interfacing with the deionized water. This architecture allows for independent control of the flow of water through the anode passage 109 without waste of expensive deionized water, and with a simple plumbing layout.

In an example, the first threshold temperature is set to a temperature of less than 30° C., a temperature less than 20° C., or a temperature in the range of 1 to 30° C., 5° C. to 24° C., 10° C. to 20° C., or 15° C. to 20° C. In an example, the second threshold temperature is set to a temperature of less than 30° C., a temperature less than 20° C., or a temperature in the range of 1 to 30° C., 5° C. to 24° C., 10° C. to 20° C., or 15° C. to 20° C. In an example, the first threshold temperature is set lower than the second threshold temperature, such as less than 5 degrees lower than the second threshold temperature or less than 10 degrees lower than the threshold temperature. In a particular example, the first threshold temperature is 18° C. and the flow rate for the water into the anode passage 109 is set such that the water output from the anode passage 109 is 20° C. or less.

It is generally preferrable to increase the flow rate of water through the cells 100 rather than reduce the temperature of the water to provide additional cooling power as it generally requires less energy to increase the flow rate. However, the water pressure drop across the anode passage 109 and the fluid connections may limit the flow rate, and so for cells that require larger cooling loads, lower temperatures may be required.

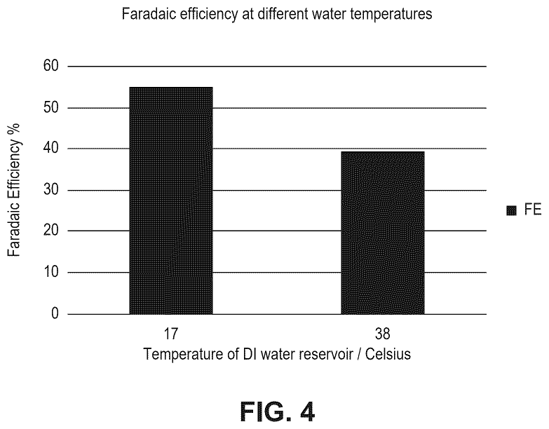

Cooling the stack 212 can provide a substantial improvement in Faradaic efficiency, as shown in FIG. 4, which compares the efficiency of an electrolytic cell stack using uncooled input water (with an internal temperature that rises to 38° C.) with an electrolytic cell stack using input water flow to maintain the output temperature of solution output from the cathode passage 105 to 18° C. In this example, the Faradaic efficiency rises from about 39% in the standard, higher temperature condition, to about 55% at lower temperature of this invention. The lifetime of the gas diffusion electrode will also increase, as it will no longer be de-activated by reacting with peroxide at elevated temperatures.

In an example, the flow rate of water through the anode passage 109 is at least twice the flow rate of water through the cathode passage 105. For example, the ratio of the flow rate through the anode passage 109 to the flow rate through the cathode passage 105 can be between 2:1 and 500:1, preferably between 3:1 and 20:1. In an example, flow rate into the anode passage 109 is between 5-15 ml/hour/cm² and the flow rate into the cathode passage 105 is between 2 and 4 ml/hour/cm². cathode passage 105 In an example, the flow rate of O² into the gas distribution layer 103 is between 0.2 and 0.4 liters per hour/cm².

In other examples, there is no water input into the cathode passage 105. In such an example, the flow rate output from the cathode passage 105 is about 0.1 to 0.2 ml/hour/cm².

In an example, the power applied to the stack 212 is more than 200 Watts.

What is claimed is:

1. An apparatus for producing hydrogen peroxide comprising:
one or more electrolytic cells, each cell having an anode, a cathode, an anode passage for passing fluid proximate the anode, and a cathode passage for capturing hydrogen peroxide produced at the cathode;
a heat exchanger configured to remove heat from deionized water;
one or more conduits fluidly coupling the deionized water downstream of the heat exchanger to the anode passage of the one or more electrolytic cells, such that the apparatus is configured to:
remove heat from deionized water with the heat exchanger;
after removing heat from the deionized water, pass the deionized water through the anode passage of the one or more cells; and
oxidize the deionized water in the anode passage of the one or more cells;
a controller configured to control the heat exchanger; and
a first one or more temperature sensors electrically coupled to the controller, the first one or more temperature sensors configured to provide a first temperature reading that is indicative of a temperature of the one or more cells, wherein the controller is configured to control the heat exchanger to maintain the first temperature reading at or below a first temperature threshold.

2. The apparatus of claim 1, comprising:
one or more second temperature sensors electrically coupled to the controller, the one or more second temperature sensors configured to provide a second temperature reading based on a temperature of the deionized water prior to the water passing through the anode passage of the one or more cells, wherein the controller is configured to control the heat exchanger to maintain the second temperature reading at or below a second threshold temperature.

3. The apparatus of claim 2, comprising:
a deionized water reservoir fluidly coupled to the heat exchanger; and
one more pumps to pump the deionized water from the water reservoir through the one or more conduits to the one or more cells,
wherein the first temperature sensor is configured to sense a temperature of the deionized water in the reservoir.

4. The apparatus of claim 3, wherein the apparatus is configured to pass at least a portion of the deionized water output from the anode passage of the one or more cells back to the deionized water reservoir.

5. The apparatus of claim 4, comprising a filter disposed in a path of the at least a portion of the deionized water output from the anode passage to filter the at least a portion of the deionized water prior to the at least a portion of the deionized water being passed into the deionized water reservoir.

6. The apparatus of claim 2, wherein control the heat exchanger includes adjust the second temperature threshold to maintain the first temperature reading at or below the first temperature threshold.

7. The apparatus of claim 6, wherein the first temperature sensor is configured to sense a temperature of a solution output from the cathode passage of the one or more cells.

8. The apparatus of claim 7, wherein the first threshold temperature is at or below 20° C. and the second threshold temperature is at or below 18° C.

9. The apparatus of claim 2, wherein the controller is configured to control the flow rate of the deionized water through the anode passage to maintain the first temperature reading at or below a first temperature threshold.

10. The apparatus of claim 1, wherein the apparatus is configured to pass a portion of the deionized water output from the anode passage of the one or more cells through the cathode passage of the one or more cells.

11. The apparatus of claim 1,
a power sensor electrically coupled to the controller, the power sensor configured to provide a power reading based on a power drawn by the one or more cells, wherein the controller is configured to control one or more of the heat exchanger and a flow rate of the deionized water through the anode passage of the one or more cells based on the power reading.

12. The apparatus of claim 1, wherein the anode and the cathode are part of a membrane electrode assembly (MEA) in which the anode and the cathode are in contact with reverse sides of an ion-exchange membrane.

13. A method of producing hydrogen peroxide comprising:
removing heat from deionized water with a heat exchanger;
after removing heat from the deionized water, passing the deionized water through an anode passage of the one or more electrolytic cells, each cell having an anode, a cathode, the anode passage for passing fluid proximate the anode, and a cathode passage for capturing hydrogen peroxide produced at the cathode;
oxidizing the deionized water in the anode passage of the one or more cells. providing one or more cells;
sensing a first temperature indicative of the temperature of the one or more cells to obtain a first temperature reading; and
controlling one or more of the heat exchanger and a flow rate of water through the anode passage of the one or more cells to maintain the first temperature reading at or below a first temperature threshold.

14. The method of claim 13, comprising:
sensing a second temperature of the deionized water prior to the water passing through the anode passage of the one or more cells to obtain a second temperature reading; and
controlling the heat exchanger to maintain the second temperature reading at or below a second threshold temperature.

15. The method of claim 14, comprising:
recirculating at least a portion of the deionized water output from the anode passage of the one or more cells back to the anode passage of the one or more cells.

16. The method of claim 15, comprising:
filtering the at least a portion of the deionized water prior to passing it back to the anode passage of the one or more cells.

17. The method of claim 16, wherein controlling one or more of the heat exchanger and a flow rate of water through the anode passage of the one or more cells includes adjusting the second temperature threshold to maintain the first temperature reading at or below the first temperature threshold.

18. The method of claim 16, wherein sensing a temperature indicative of a temperature of the one or more cells includes sensing a temperature of solution output from the cathode passage of the one or more cells.

19. The method of claim 18, wherein the first threshold temperature is at or below 20° C. and the second threshold temperature is at or below 18° C.

20. The method of claim 13, comprising:
sensing a power drawn by the one or more cells; and
controlling one or more of the heat exchanger and a flow rate of the deionized water through the anode passage of the one or more cells based on the power drawn by the one or more cells.
